(19) United States
(12) Patent Application Publication
(10) Pub. No.: US 2009/0050662 A1
(43) Pub. Date: Feb. 26, 2009

(54) Clear Lucite cutting tool

(76) Inventors: Randy Dean Hufford, Kula, HI (US); Richard Orville Hufford, Dana Point, CA (US); Kyle Nicholas Hufford, Long Beach, CA (US)

Correspondence Address: Kyle Hufford/ZORC PRODUCTIONS, INC., 4835 E. Anaheim St., #216, LONG BEACH, CA, 90804, US

(21) Appl. No.: 10/709,645

(22) Filed: May 19, 2004

(51) Int. Cl. B26F 3/02; B26D 1/02

(52) U.S. Cl. 225/17; 83/856; 225/91

(57) ABSTRACT

The Dual Edge Ripper is a tool designed to give a hand-torn deck-led edge to photographs, art papers and writing papers. The ripper is designed to be placed on top of any paper that needs a hand-torn deckle edge wherein the edge of the paper is pulled up toward the user effecting the cut. One edge creates a slightly rough cut and the opposite side creates a rougher cut. The dual edge ripper is manufactured in 2 lengths—12″ and 24″. Made from ⅛″ clear Lucite the overall dimension is ⅛″×4×12 or ⅛″×4×24.

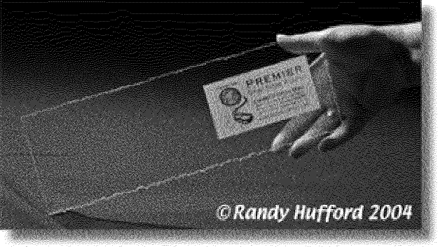

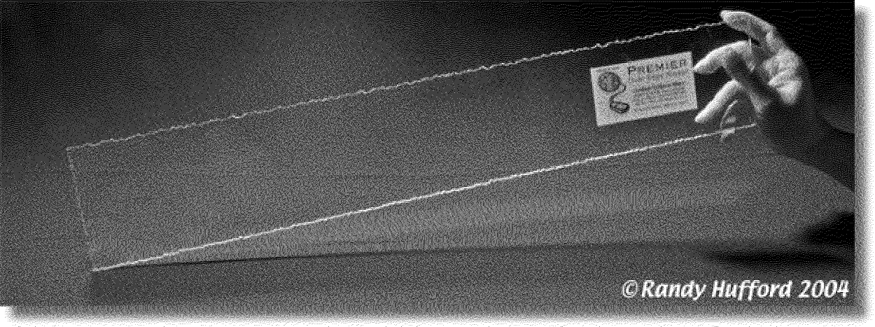

### DETAILED DESCRIPTION

The cutting tool is comprised of ⅛″×4″ clear Lucite. The hand torn deckle edge effected by the cutting tool exposes the natural fibers of papers.

It is desirable for the cutting tool to be used on a work surface that does not have rounded edges. The clear Lucite tool is placed on top of the desired paper that needs the hand torn deckle edge and the paper is pulled up effecting the tear.

The use of the clear Lucite material for this invention provides the functionality of being able to line up your tear exactly where you want it.

1. A method of giving a rough hand torn deckle edge by using the rough cut side of the cutting tool.

2. A method of giving a gentle hand torn deckle edge by using the smoother cut side of the cutting tool.

3. A method according to claim 1 and 2 wherein the invention is a 12″ length and is used specifically for the scrap booking market as well as for deckling letters.

4. A method according to claim 1 and 2 wherein the invention is a 24″ length and can be used in all applicable markets
